(19) United States
(12) Patent Application Publication
(10) Pub. No.: US 2006/0085416 A1
(43) Pub. Date: Apr. 20, 2006

(54) Information reading method and information reading device

(76) Inventors: Kanae Naoi, Uji-shi (JP); Mitsuru Minakuchi, Soraku-gun (JP)

Correspondence Address: BIRCH STEWART KOLASCH & BIRCH, PO BOX 747, FALLS CHURCH, VA, 22040-0747, US

(21) Appl. No.: 10/547,544

(22) PCT Filed: Mar. 1, 2004
(86) PCT No.: PCT/JP04/02514

§ 371 Date: Sep. 1, 2005

(30) Foreign Application Priority Data
Mar. 5, 2003 (JP) 2003-058450

(51) Int. Cl. G06F 17/30

(52) U.S. Cl. 707/6

(57) ABSTRACT

An information viewing apparatus (100) includes an information receiving apparatus (108) for selecting information as an object to be presented to the user from information provided from a prescribed information source (102, 104 and 106), a user profile storage apparatus (128) storing user profile information representing user's interest and preference, a comparison control apparatus (134) comparing the selected information and the user profile information and calculating a degree of conformity, and based on the degree of conformity, forming conformity information representing conformity between the selected information and the user profile information, and information display control apparatus (114) and information display apparatus (116) for presenting the conformity information together with the selected information.

### TECHNICAL FIELD

The present invention relates to an information viewing method and an information viewing apparatus that calculate a degree of conformity between information being viewed by a user and interest or preference of the user, for supporting selection of information by the user utilizing the calculated degree of conformity.

### BACKGROUND ART

Recently, wide variety of information has come to be distributed to homes through multimedia including CATV (Community Antenna Television or Cable Television), digital satellite broadcast and the Internet. Various dedicated multimedia channels have been provided not only for providing various and many programs but also for enabling distribution services to suit various tastes of the users, resulting in formidable number of service channels.

When a user views information provided by such multimedia, the user is required to select a channel that is believed to address a topic of interest to the user among the service channels, and to look for and select a right program on that channel. It has been more and more difficult for the user to make such a selection among ever-increasing channels and ever-increasing programs of late, and the burden on the user becomes heavier.

As a method of supporting user's selection of information he/she wishes to see, a method of narrowing down the provided information only to pieces that suit the taste of the user has been known. This method includes the following steps of: forming a set (hereinafter referred to as “user profile”) of information (hereinafter referred to as “user profile information”) representing topics of interest to the user, comprised of a history of programs viewed by the user, pre-set keywords and the like; choosing a program that suits user's taste among a huge number of distributed programs, based on the user profile information; and providing only the chosen program to the user.

By way of example, the method of providing information described in Japanese Patent Laying-Open No. 2000-250944 includes the steps of: appending to multimedia information, data representing an attribute of the information, to form a database; searching for multimedia information that suits user's taste by collating the user profile with the information attribute; and providing only the information searched out in the step of searching with the user.

As another example, Japanese Patent Laying-Open No. 2000-29902 discloses a system that improves accuracy in searching, to alleviate the trouble of the user to look for the intended information. The system includes: a document classifying device including a structural feature extractor for extracting a feature such as a tag included in an HTML (Hyper Text Markup Language) document or a keyword, and a collating unit calculating a degree of conformity through collation with a rule; and a narrowing-down unit removing documents having conformity not higher than a prescribed degree and displaying the narrowed-down result.

The conventional method or apparatus that narrows down information to be provided by using search method or the like may involve the following problems:

(1) When the user turns his/her interest from one object to another, the narrowed down information may not include information related to the object of new interest; and

(2) Not all the pieces of information related to the object of interest to the user are always included in the narrowed-down information.

Therefore, the user may suspect that information that the user is eager to view exists outside the narrowed-down result.

The problems described above may arise even when all the narrowed-down pieces of information were related to any of the objects that have attracted the user's interest.

When the problem described above occurs, the user cannot help but give up narrowing-down the information to be viewed by the conventional method, and to search for the desired information by viewing all available pieces at random.

### DISCLOSURE OF THE INVENTION

The present invention was made in view of the foregoing, and one object is to provide an information viewing method supporting selection of information by the user without causing the problem that information provided to the user is limited, a recording medium recording a program therefor, and an information viewing apparatus.

Another object of the present invention is to provide an information viewing method reducing the time necessary for the user to search for information he/she wishes to see and reducing the trouble experienced by the user in searching for the information, a recording medium recording a program therefor, and an information viewing apparatus.

A still further object of the present invention is to provide an information viewing method that can support selection of information when the user is wondering what to view, a recording medium recording a program therefor, and an information viewing apparatus.

A further object of the present invention is to provide an information viewing apparatus that forms a user profile suited for user's taste, alleviates user's trouble in editing the user profile, and that can support selection of information presently of interest to the user, as well as a recording medium recording a program therefor, and an information viewing apparatus.

According to a first aspect, the present invention provides an information viewing method, supporting selection by the user of a piece of information to be viewed. The method includes the step of selecting, from pieces of information provided from a prescribed information source, a piece of information as an object to be presented to the user, based on a user input; the step of storing user profile information representing user's interest and preference; the first step of comparing the piece of information selected in the selecting step with the user profile information stored in the storing step and calculating degree of conformity therebetween; and a second step of presenting information reflecting the degree of conformity together with the information selected in the selecting step.

In the information viewing method in accordance with the first aspect of the present invention, the information selectable by the user is unlimited. The user can freely select information, and information reflecting the degree of conformity representing how well the selected piece of information conforms to the user's taste is also indicated. The user can freely select from a mass of information and, on the other hand, can readily know what piece of information possibly attracts high attention of the user.

Preferably, the information viewing apparatus further includes the step of editing the user profile information stored in the storing step, based on a user input.

The information viewing method may further include the third step of storing history of information selection in the selecting step.

More preferably, the information viewing method further includes means for extracting a piece of information related to an object of interest to the user, from any of the history and pieces of information stored together with the history, and editing the user profile information based on the extracted information related to an object.

When the user turns his/her interest from one object to another, the user profile information can be modified to reflect the preference of the user that has changed. The degree of conformity is also calculated based on the modified user profile, even for the information related to the changed object of interest. Therefore, the information presented in accordance with the degree of conformity can reflect user's interest and preference. Thus, the method can flexibly adapt to the change in user's preference.

Preferably, the information presenting method further includes the third step of comparing a piece of information not selected in the selecting step with the user profile information stored in the storing step and calculating a degree of conformity between the non-selected piece of information and the user profile; and the fourth step of presenting to the user as secondary information, presence of the non-selected information, when the degree of conformity calculated in the third step satisfies a prescribed condition.

When pieces of information not viewed by the user at present include information possibly of high interest to the user, such information is presented. This can support selection of information by the user, when the user is wondering which information should be selected.

The information viewing method may further include the step of forming and displaying a list allowing the user to view the history stored in the history storing step or the information stored with the history, or both the history and information.

More preferably, the information viewing method further includes the step of causing selection of the user-selected information in the selecting step, in accordance with the selection of information by the user using items of the list displayed in the display step.

It may sometimes be difficult for the user to select desired information among unlimited groups of information. Alternatively, sometimes the user may wish to select information from narrowed-down pieces of information. In such a case, it may be possible to reduce the time for search, by displaying only the selectable information in a limited manner and allowing the user to select therefrom.

According to a second aspect, the present invention provides a computer readable recording medium recording a program that can be executed by a computer. The program recorded on the recording medium controls operation of the computer to execute the information viewing method according to the first aspect of the present invention.

When the program recorded on the recording medium is read and executed by a computer, the function and effect of the present invention in accordance with the first aspect above can be realized by the computer.

According to a third aspect, the present invention provides an information viewing apparatus, including: information selecting means for selecting, from pieces of information provided from a prescribed information source, a piece of information as an object to be presented to the user, based on a user input; user profile storing means for storing user profile information representing user's interest and preference; first means (122, 134) for calculating degree of conformity for comparing the piece of information selected by the information selecting means with the user profile information stored by the user profile storing means, and for calculating degree of conformity therebetween; and first means for presenting the information reflecting the degree of conformity and the selected piece of information selected by the information selecting means together.

### BRIEF DESCRIPTION OF THE DRAWINGS

FIG. 1 is a block diagram representing a configuration of an information transmitting system including an information viewing apparatus 100 in accordance with a first embodiment of the present invention.

FIG. 2 is a flow chart of a process performed by information viewing apparatus 100 in accordance with the first embodiment of the present invention.

FIG. 3 shows an example of an input method when a user profile is edited by information viewing apparatus 100 in accordance with the first embodiment of the present invention.

FIG. 4 shows an example of the user profile stored by a user profile storage apparatus 128 of information viewing apparatus 100 in accordance with the first embodiment of the present invention.

FIG. 5 shows an image plane of an information display apparatus 116, when information viewing apparatus 100 in accordance with the first embodiment of the present invention displays received information and a marker of conformity information.

FIG. 6 shows an image plane of information display apparatus 116, when information viewing apparatus 100 in accordance with the first embodiment of the present invention displays information with low degree of conformity.

FIG. 7 is a block diagram representing a configuration of an information transmitting system including an information viewing apparatus 700 in accordance with a second embodiment of the present invention.

FIG. 8 is a flow chart of a process performed by information viewing apparatus 700 in accordance with the second embodiment of the present invention.

FIG. 9 shows an image plane of information display apparatus 116, when information viewing apparatus 700 in accordance with the second embodiment of the present invention presents recommended information.

FIG. 10 shows an image plane of information display apparatus 116, when information viewing apparatus 700 in accordance with the second embodiment of the present invention indicates that formation of the recommended information has been complete.

FIG. 11 is a block diagram representing a configuration of an information transmitting system including an information viewing apparatus 1100 in accordance with a third embodiment of the present invention.

FIG. 12 is a flow chart of a process performed by information viewing apparatus 1100 in accordance with the third embodiment of the present invention.

FIGS. 13 and 14 show image plane of information display apparatus 116, when information viewing apparatus 1100 in accordance with the third embodiment of the present invention displays a history list.

FIG. 15 shows an appearance of an exemplary computer system 1500 realizing the first, second and third embodiments of the present invention.

FIG. 16 shows an exemplary computer system 1500 realizing the first, second and third embodiments of the present invention.

### BEST MODES FOR CARRYING OUT THE INVENTION

Embodiments of the present invention will be described in the following with reference to the figures. In the figures referred to in the following description, the same components are denoted by the same reference characters. They have the same names and functions. Therefore, detailed description thereof will not be repeated.

### FIRST EMBODIMENT

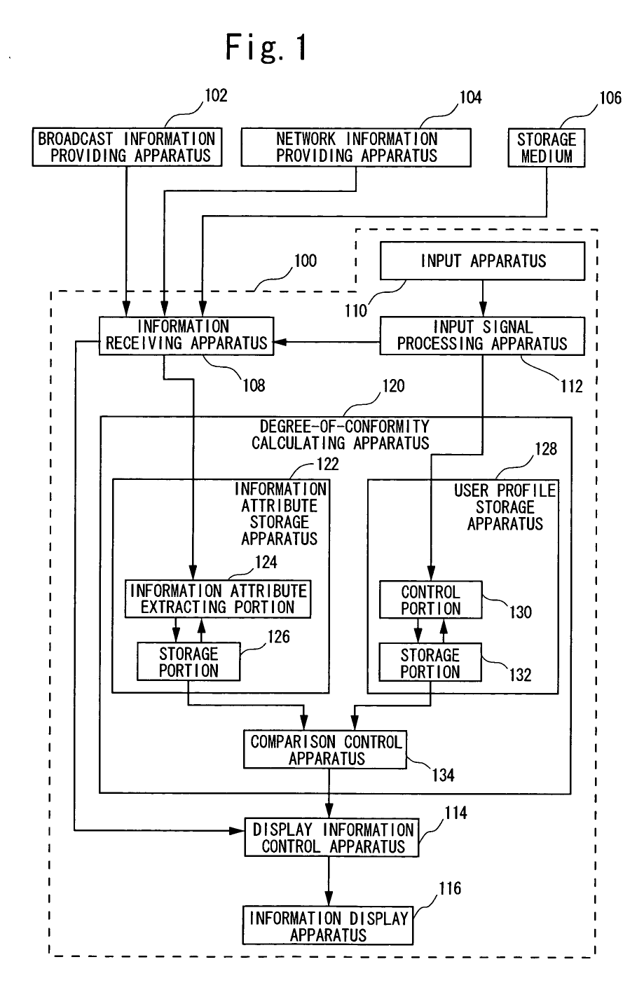

FIG. 1 shows, in the form of a block diagram, a configuration of an information transmitting system including an information viewing apparatus 100 in accordance with a first embodiment of the present invention. Referring to FIG. 1, the information transmitting system includes: a broadcast information providing apparatus 102 sending broadcast information from a broadcasting station of CATV, digital satellite broadcast and the like, a network information providing apparatus 104 providing information held by a server on a network, or a recording medium 106 such as a CD-ROM (Compact Disk Read-Only Memory), as an information source providing various pieces of information including video images and programs to the user; and an information viewing apparatus 100 in accordance with the present embodiment, receiving information from the information source.

Information viewing apparatus 100 includes: an information receiving apparatus 108 connected to the afore-mentioned information source for receiving information selected by a user; an input apparatus 110 serving as an interface for the user input, in an operation of selecting information the user wishes to see, that is, the information to be viewed using the information viewing apparatus 100, in an operation of editing user profile information and the like, and in other operations by the user to the information viewing apparatus 100; an input signal processing apparatus 112 connected to receive a signal from input apparatus 110 for analyzing a signal received from input apparatus 110 and emitting an instruction signal to information receiving apparatus 108 and to a degree-of-conformity calculating apparatus 120, which will be described later.

Information viewing apparatus further includes: the degree-of-conformity calculating apparatus 120 connected to information receiving apparatus 108 and input signal processing apparatus 112, receiving an instruction signal from input signal processing apparatus 112, calculating a degree of conformity by comparing attribute of information selected by the user and received by information receiving apparatus 108 (hereinafter the information will be referred to as “selected information”) with a user profile, and outputting information including the degree of conformity, conforming category, a key word and the like, representing conformity between the selected information and the user profile (hereinafter the information will be referred to as “conformity information”).

Information viewing apparatus 100 further includes: a display information control apparatus 114 connected to information receiving apparatus 108 and to degree-of-conformity calculating apparatus 120, receiving information from information receiving apparatus 108 and to degree-of-conformity calculating apparatus 120 and processing the received information to form information to be presented; and an information display apparatus 116 implemented by an output apparatus including one of or both of a display apparatus, such as a CRT (Cathode Ray Tube) or a liquid crystal display, and a sound output apparatus including an amplifier and a speaker, connected to display information control apparatus 114 and presenting the display information formed by display information control apparatus 114 to the user.

Degree-of-conformity calculating apparatus 120 has a function of calculating the degree of conformity by comparing the selected information and the user profile, that is, a function of extracting and storing attribute of the selected information (hereinafter the attribute will be referred to as “information attribute”), comparing the information attribute with the user profile, and calculating the degree of conformity. Degree-of-conformity calculating apparatus 120 includes: an information attribute storage apparatus 122 connected to information receiving apparatus 108 for extracting information attribute from the selected information and storing the same; a user profile storage apparatus 128 connected to input signal processing apparatus 112 for editing user profile based on an instruction signal from input signal processing apparatus 112 and storing the same; and a comparison control apparatus 134 connected to information attribute storage apparatus 122 and user profile storage apparatus 128, comparing the information attribute stored in information attribute storage apparatus 122 with the user profile stored in user profile storage apparatus 128 to calculate the degree of conformity, and forming and outputting conformity information based on the calculated degree of conformity.

Information attribute storage apparatus 122 includes an information attribute extracting portion 124 receiving the selected information from information receiving apparatus 108 and extracting the information attribute, and a storage portion 126 storing the information attribute extracted by information attribute extracting portion 124.

User profile storage apparatus 128 includes a control portion 130 editing the user profile based on the instruction signal from input signal processing apparatus 112, and a storage portion 132 storing the user profile edited by control portion 130.

In this example, information receiving apparatus 108 receives only the information selected by the user. It may, however, be adapted to receive in advance the information attribute of information that will be provided in the future. By way of example, using information of a program table distributed in an electronic form, information of programs of one day, or information of a program to be broadcast next to the program currently broadcast on the same channel as the channel providing the selected information at present, may be obtained beforehand. Alternatively, all the programs that are broadcast currently may be received by information receiving apparatus 108. Information attribute extracting portion 124 of information attribute storage apparatus 122 may extract information attribute only from the selected current program, or may extract information attribute from a program to be broadcast in the future on the same channel.

Input apparatus 110 may be an input apparatus implemented by buttons, a dial or keys attached to the body of information viewing apparatus 100, or it may be a keyboard or the like connected to the body of information viewing apparatus 100. A remote controller or the like that transmits a signal through infrared ray may be used as input apparatus 110. A pointing device such as a mouse or a touch panel for operating GUI (Graphical User Interface) element displayed on the screen may also be used as input apparatus 110. Any other means may be used, provided that a user operation can be transmitted in the form of a signal.

Connection between input apparatus 110 and input signal processing apparatus 112 may be wired connection, wireless connection, infrared connection, physical connection or any other form of connection, provided that the signal from input apparatus 110 can be transmitted.

When the information to be provided is voice information or information including voice, a sound output apparatus including an amplifier, a speaker and the like may be used as an example of information display apparatus 116. Any other apparatus of any form or configuration may be used as information display apparatus 116 that is suitable for presenting the selected information.

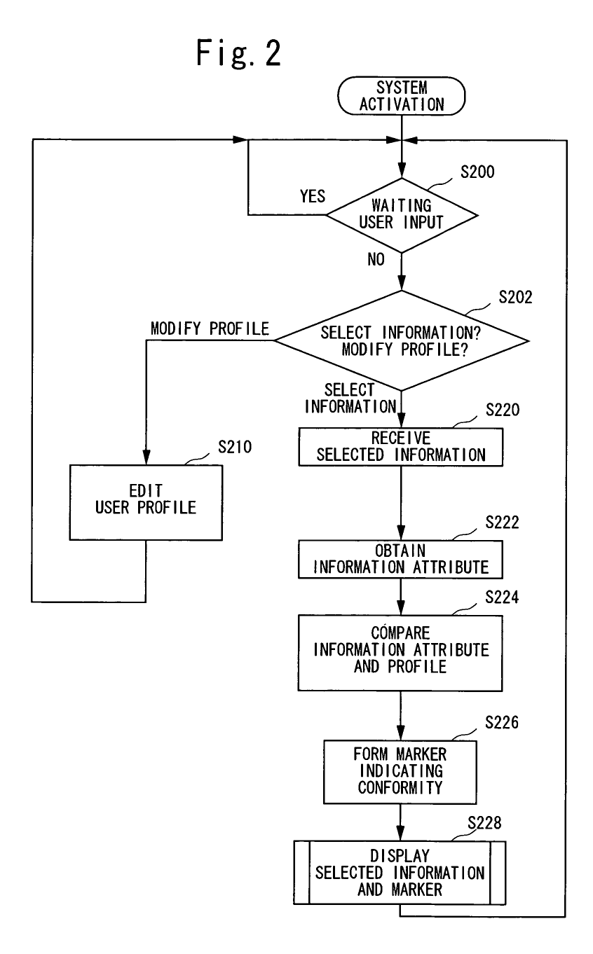

In the following, a control structure of a program for realizing a desired function related to the system of information viewing apparatus 100 of the present embodiment will be described. FIG. 2 is a flow chart of the information viewing program executed by information viewing apparatus 100. The information viewing program is executed repeatedly from the activation of the system of information viewing apparatus 100 until the end of operation of the system.

Referring to FIG. 2, when the system of information viewing apparatus 100 shown in FIG. 1 is activated, information viewed by the user at the end of last system operation or information set by the user as initial setting appears as the initial state, and then, control proceeds to step (hereinafter simply denoted by “S”) 200.

In S200, information viewing apparatus 100 is in a standby state of waiting for an operation input from the user. When input signal processing apparatus 112 shown in FIG. 1 receives a signal from input apparatus 110, the standby state ends, and control proceeds to S202.

In S202, input signal processing apparatus 112 determines the operation performed by the user, based on the input signal received from input apparatus 110. Specifically, it is determined whether the user operation is an operation for editing the user profile, or an operation for selecting information to be viewed. If the user operation is for editing the user profile, input signal processing apparatus 112 emits an instruction signal to degree-of-conformity calculating apparatus 120, and control proceeds to S210. If the user operation is for selecting information to be viewed, input signal processing apparatus 112 emits an instruction signal to information receiving apparatus 108, and control proceeds to S220.

In S210, control portion 130 of user profile storage apparatus 128 shown in FIG. 1 receives the instruction signal from input signal processing apparatus 112. Control portion 130 modifies the user profile stored in storage portion 132, in accordance with the instruction signal.

In S220, information receiving apparatus 108 receives, among receivable pieces of information, the information selected by the user using input apparatus 110, and transmits the received information to display information control apparatus 114 and to degree-of-conformity calculating apparatus 120. Then, control proceeds to S222.

In S222, information attribute extracting portion 124 of information attribute storage apparatus 122 shown in FIG. 1 receives the selected information, extracts the information attribute from the selected information, and stores the same as database, in storage portion 126. Then, control proceeds to S224.

In S224, comparison control apparatus 134 collates and compares the information attribute stored in storage portion 126 with the user profile stored in storage portion 132, calculates the degree of conformity thereby, forms conformity information including the degree of conformity, conformed category, keyword and the like, and transmits the thus formed information to display information control apparatus 114. Control proceeds to S226.

In S226, display information control apparatus 114 forms a marker to present the conformity information to the user in an easy-to-understand manner. Details of the marker will be described later. Control proceeds to S228.

In S228, display information control apparatus 114 receives the selected information from information receiving apparatus 108, forms display information by combining the selected information and the marker of S226, and transmits the display information to information display apparatus 116. Information display apparatus 116 outputs the display information. Then, control returns to S200.

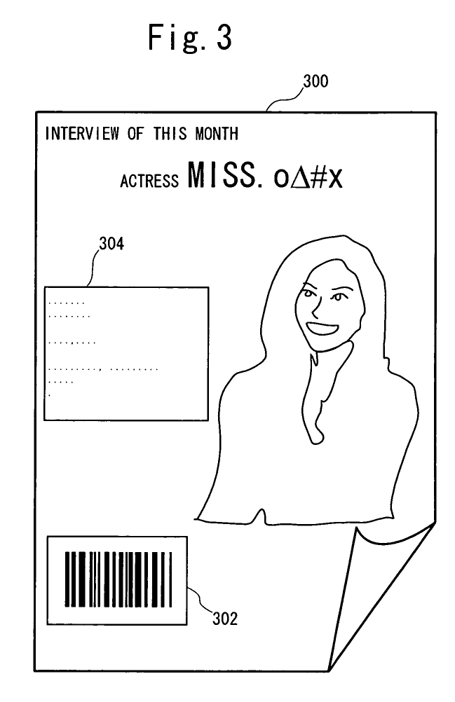

An exemplary operation of information viewing system in accordance with the present embodiment will be described with reference to FIGS. 3 to 6, in accordance with the control structure shown in FIG. 2. In the following, description will be given on an example in which the user edits the user profile, an example in which the received information is selected, and so on.

When the apparatus is activated, the program having a control structure such as shown in FIG. 2 is activated, waiting for a user operation in S200. When the user performs an operation of editing the user profile, control proceeds from S200 through S202 to S210. An example of the method by which the user edits the user profile in S210 is as follows.

By way of example, a keyword of interest to the user may be input using a keyboard as input apparatus 110. Alternatively, among keywords registered in advance category by category, a keyword of interest may be selected. Further, the user may select information attribute of the selected information viewed at present, secondary information included in the selected information, or part of or all of the selected information.

Further, input apparatus 110 may additionally be provided with a function of reading a bar code or characters, a bar code 302 related to contents of a magazine may be attached to a page 300 of the magazine as shown in FIG. 3, and the bar code 302 may be read by input apparatus 110. Alternatively, input apparatus 110 may read characters 304 written on a page 300, rather than inputting a keyword or category.

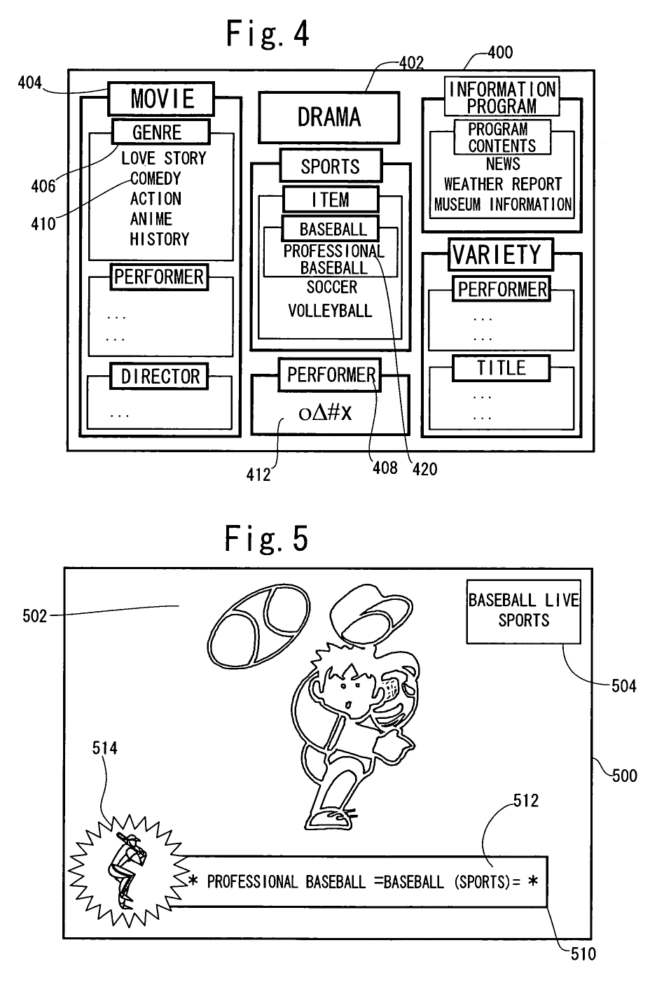

FIG. 4 shows an example of the user profile, which is input by the user, edited by control portion 130 in user profile storage apparatus 128 and stored in storage portion 132.

In the example shown in FIG. 4, user profile 400 forms a set of keywords (first keyword 410, second keyword 412, . . . ) classified category by category (first category 402, second category 404, third category 406, fourth category 408, . . . ).

For instance, when a user is interested in drama programs in general, and adds information representing drama programs in general to the user profile 400 through an input operation such as described above, it will be stored as the first category 402, in user profile 400. When the user is particularly interested in comedy movies among movies and adds information representing comedy movies to user profile 400, it will be stored as a keyword 410 in the third category 406 representing the movie genre, in the second category 404 representing movies in general. When the user is interested in anything in which a specific person appears as a performer regardless of the category such as the first and second categories 402 and 404, it will be stored as a keyword 412 in the fourth category 408 as a set of keywords representing specific performers independent from the first and second categories 402 and 404.

These categories and keywords stored in user profile 400 may additionally have priority (order of priority) as secondary information, reflecting how much the user is interested.

Next, when the user makes an operation of selecting information to be received, the apparatus operates in the following manner. Control proceeds from S200 and S202 to S220. In S220, the selected information selected by the user is transmitted to display information control apparatus 114 and information attribute storage apparatus 122 of degree-of-conformity calculating apparatus 120, as described above. Information attribute extracting portion 124 extracts attribute of a program from the selected information.

The attribute of information to be extracted includes, by way of example, a title and identification number of the selected information, summary of contents attached in advance to the selected information, secondary information such as a keyword representing classification of the information, and the number of times the user viewed the information. Alternatively, a part of or all of a string of characters, images or sounds constituting the contents of the selected information may be extracted as the information attribute. Further, the sound of selected information converted to text information using speech recognition technique, data for image recognition formed from the selected information for comparing the image or video information using image recognition technique may be extracted as the information attribute.

Further, the information attribute may be obtained from a server apparatus providing information attribute on a network, using information such as an identification number for uniquely identifying the selected information or the title of the selected information.

Information attribute extracting portion 124 has the information attribute extracted from the selected information stored in storage portion 126. Then, control proceeds to S224.

In S224, comparison control apparatus 134 reads the information attribute from storage portion 126 and reads the user profile from storage portion 132, collates and compares the information attribute with the user profile, and calculates the degree of conformity. Here, examples of the method of calculating degree of conformity may include the following.

As an example, a method may be used in which a keyword stored as the information attribute is compared with a keyword and a category of the user profile and the degree of coincidence is calculated therefrom. As another example, the degree may be calculated based on the number of times the user viewed the information. Alternatively, priorities may be attached beforehand to the user profile, and information that matches a keyword of high priority may be regarded as information having high degree of conformity. When the stored information attribute is text information such as sentences, the degree of relevance between the information attribute and the user profile may be calculated using a technique of meaning comprehension utilizing a summary or a thesaurus. Further, when the stored information is image information, the degree of relevance between the information attribute and the user profile may be calculated using a search technique based on illustration comparing the similarity of images, or a technique of image comprehension that recognizes an object included in the image.

Further, for each of the stored information attributes, degree of conformity with the user profile may be calculated one by one, and the total may be used as the degree of conformity. By way of example, among the information attributes, the number of attributers of which separately calculated degree of conformity is not lower than a prescribed threshold may be counted, and the resulting number may be used as the degree of conformity. Alternatively, the number of attributers of which separately calculated degree of conformity is not lower than a prescribed threshold may be counted, and if the resulting number is not lower than a prescribed value, the information may be regarded as having high degree of conformity. Further, a group of pieces of information consisting of separately calculated degrees of conformity may be used as the degree of conformity. Besides, any other general technique may be used to calculate the degree of relevance between the information attribute and the user profile, and the result may be used as the degree of conformity.

After the degree of conformity is calculated using such a method as described above, the conformity information is formed from the calculated degree of conformity and the keyword or category having high degree of conformity, and the information thus formed is transmitted to display information control apparatus 114. Then, control proceeds to S226.

In S226, based on the conformity information received by display information control apparatus 114, display information control apparatus 114 forms a marker of conformity information, and control proceeds to S228, in which the display information is formed.

Examples of the marker of conformity information displayed together with the selected information may include the following. For instance, a certain threshold may be set, and for information having the degree of conformity not lower than the threshold, a marker may indicate that the currently received information has high degree of conformity. Colored markers may be used, such as a red marker indicating the degree of conformity lower than 0.5, yellow indicating degree of 0.5 to 0.8, and blue indicating 0.8 or higher. A keyword having a high degree of conformity, and a category to which the keyword belongs may be displayed by characters, and the characters may serve as the marker. A mark or color representing a keyword may be set for each keyword, and may be used as the marker. Further, when display information control apparatus 114 receives conformity information including a set of pieces of information consisting of separate degrees of conformity for respective information attributes, a marker corresponding to the degree of conformity may be formed for each one of the information attributes.

The marker of conformity information is not limited to visual markers, and sound information notifying a keyword of high degree of conformity or a melody set for each keyword may be used as the marker. When such an audio marker is used, information display apparatus 116 naturally includes a sound output apparatus for outputting the sound marker.

Referring to user profile 400 as an example, display information that is displayed corresponding to the degree of conformity will be described.

FIG. 5 shows an example of the display information given when a program of live-coverage of professional baseball game is received and viewed by the viewing apparatus 100. It is assumed that the user is interested in the contents of the program.

In this example, the information attribute extracted from selected information 502 includes “sports”, “baseball live” and “professional baseball”.

In user profile 400 shown in FIG. 4, a keyword 420 representing “professional baseball” has already been registered. Here, comparison control apparatus 134 of degree-of-conformity calculating apparatus 120 transmits the degree of conformity, the matched keyword “professional baseball” and categories “baseball” and “sports” to which keyword 420 belongs, to display information control apparatus 114 as the conformity information.

Display information control apparatus 114 receives the conformity information and forms a marker 504 representing the title of the selected information 502 and the category to which the selected information belongs, as well as a marker 510 for presenting the conformity information to the user. The marker 510 shown in FIG. 5 includes character information “professional baseball” representing the matched keyword 420, character information 512 of “baseball” and “sports” representing the category to which the keyword belongs, and an image 514 visually representing the category “baseball”.

After forming the markers, display information control apparatus 114 forms display information, by putting together the selected information 502, marker 504 representing the title of the selected information 502 and the category to which the selected information belongs, and marker 510, and outputs the display information to information display apparatus 116. Consequently, the user can determine at one sight that the currently viewed information is of interest to the user.

In S228, when the selected information and the marker of conformity information are displayed together and the display of conformity information hinders the view, the marker may be automatically removed from the display information after a prescribed time period from the start of viewing the selected information. Thus, the marker does not hinder the user in viewing the information. Alternatively, the manner of display of the marker may be changed by the user using input apparatus 110 such as a remote controller, and when the user does not require display of the conformity information, the user can change the size of the marker, or may turn off the display of the marker.

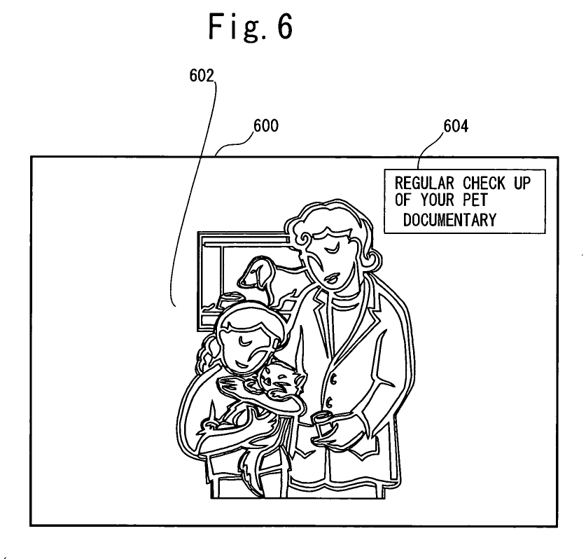

FIG. 6 shows exemplary display information when a user is watching a documentary program “Regular Check-up of Your Pet”. It is assumed that the user is not interested in this program.

In this example, the information attributes extracted from selected information 602 include “documentary”, “animal” and “health”. The user profile does not include any keyword or category related to “documentary”, “animal” and “health”. In this case, the degree of conformity between the selected information and the user profile is low. Comparison control apparatus 134 of degree-of-conformity calculating apparatus 120 transmits the degree of conformity and the information attributes of the selected information as the conformity information, to display information control apparatus 114.

Receiving the conformity information with low degree of conformity, display information control apparatus 114 does not form any marker of conformity information, but forms a marker 604 representing the title and category of the selected information. Display information control apparatus 114 forms display information putting together the formed marker 604 and the selected information 602 applied from information receiving apparatus 108, and outputs the same to information display apparatus 116. On the screen 600 of information display apparatus 116, a marker 510 of conformity information such as shown in FIG. 5 is not displayed, and only the selected information 602 and the formed marker 604 are displayed. The user can determine at one sight that the currently viewed information is not of interest to the user.

When the degree of conformity is low, comparison control apparatus 134 may send only the degree of conformity as the conformity information to display information control apparatus 114. In that case, display control apparatus 114 outputs only the selected information applied from information receiving apparatus 108 to information display apparatus 116. On the screen 600 of information display apparatus 116, only the selected information 602 is displayed.

When the contents of the information selected by the user change over time, the display of marker of conformity information such as shown in FIGS. 5 and 6 is not limited to the time zone in which the information is being presented.

For instance, between programs, or in a program, a CM (Commercial Message) may be broadcast, as in television broadcast. In such a case, conventionally, the user was not able to determine what program will be on-air after the end of the time zone of the CM broadcast.

In information viewing apparatus 100 in accordance with the present embodiment, it is possible to present, as a marker, the conformity information of the program that will be broadcast after the end of the CM. Therefore, the user can determine whether the program to be broadcast after the end of the CM is of interest or not, without waiting for the end of the CM. Further, the user need not worry whether he/she would miss an interesting program when he/she switches to other channel before the end of the CM.

Assume that the user selected a music program, for example, and 20 minutes after, a favorite singer of the user performs. Even if the user is not interested in any of the singers who perform by that time, conventionally, the user would have been kept watching the selected music program for 20 minutes until the user knows that his/her favorite singer performs. If the user switched to other channel during this 20 minutes period and viewed a different program, the user would miss the music program in the time zone of the favorite singer's performance, as the user does know that the singer would appear in 20 minutes.

If any keyword or category related to the singer is stored in user profile storage apparatus 128, information viewing apparatus 100 of the present embodiment can notify, as the conformity information, that the singer will perform, simultaneously with the selection of this music program by the user.

In addition to the conformity information, a function of indicating after how many minutes the contents of high degree of conformity will be presented, or a function of skipping information until a scene in which such information appears, may be provided for further improving convenience to the user.

### SECOND EMBODIMENT

In the first embodiment, degree of conformity between information attribute of selected information selected by the user and the user profile is calculated. The present invention, however, is not limited to such an embodiment.

Sometimes, information of interest to the user exists among pieces of information that are available or will be available soon, besides the information that is currently selected and viewed by the user. By way of example, there may be a plurality of information sources providing information, and a piece of information provided by a separate information source may be of higher interest to the user than the information that is currently selected and viewed by the user. Among pieces of information stored in a storage medium or the like that can be viewed, there may be a piece of information of high interest to the user but the fact that the piece had been stored might be forgotten. Further, though the information currently viewed is not of interest to the user, a piece of information expected to be provided immediately thereafter may be highly interesting to the user. In such a case, it is desired to support selection of information so that the user can satisfactorily select the information of interest.

In view of the foregoing, the information viewing apparatus in accordance with the second embodiment of the present invention has a function of calculating and presenting the degree of conformity between the user profile and information attribute of information that is available or will be available soon but not currently viewed by the user (in the following, the information will be referred to as “non-selected information”), in addition to the information attribute of the selected information, while the user is viewing information. Because of this function, when it is difficult for the user to find information of interest to him/her, the information viewing apparatus in accordance with the second embodiment can automatically present information of high degree of conformity, that is, information possibly of high interest to the user, and thus, supports user's search for the desired information.

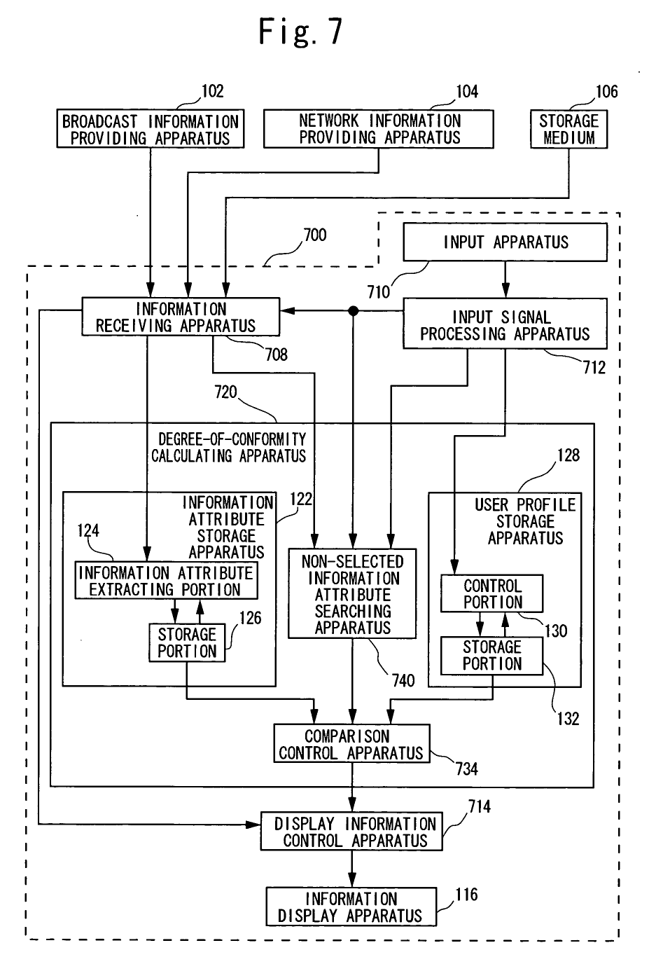

FIG. 7 is a block diagram representing a configuration of the information transmitting system including an information viewing apparatus 700 in accordance with the present embodiment. Referring to FIG. 7, information viewing apparatus 700 is connected to an information source such as broadcast information providing apparatus 102, network information providing apparatus 104 or recording medium 106.

Information viewing apparatus 700 includes an input apparatus 710, an input signal processing apparatus 712, an information receiving apparatus 708, a degree-of-conformity calculating apparatus 720, a display information control apparatus 714, and an information display apparatus 716.

Degree-of-conformity calculating apparatus 720 includes information attribute storage apparatus 122, user profile storage apparatus 128, a comparison control apparatus 734, and a non-selected information attribute searching apparatus 740. Information attribute storage apparatus 122 includes information attribute extracting portion 124 and a storage portion 126. User profile storage apparatus 128 includes control portion 130 and storage portion 132.

Of the apparatuses included in degree-of-conformity calculating apparatus 720, details of comparison control apparatus 734 and non-selected information attribute searching apparatus 740 will be described later.

Information viewing apparatus 700 is different from information viewing apparatus 100 in accordance with the first embodiment shown in FIG. 1 in that degree-of-conformity calculating apparatus 720 includes non-selected information attribute searching apparatus 740.

Non-selected information attribute searching apparatus 740 is connected to input signal processing apparatus 712, and has a function of receiving an instruction signal from input signal processing apparatus 712 and a function of monitoring an instruction signal emitted by input signal processing apparatus 712 to information receiving apparatus 708. Further, non-selected information attribute searching apparatus 740 is connected to information receiving apparatus 708 and has a function of selectively receiving non-selected information from information receiving apparatus 708, based on the monitored instruction signal. Further, non-selected information attribute searching apparatus 740 has a function of extracting information attribute of the received non-selected information, and a function of transmitting the extracted information attribute to comparison control apparatus 734.

As the degree-of-conformity calculating apparatus includes non-selected information attribute searching apparatus 740, information viewing apparatus 700 in accordance with the present embodiment differs from information viewing apparatus 100 in the following points.

(1) Information receiving apparatus 708 receives not only the information selected by the user but all the information that can be currently received, as well as keywords representing contents of such pieces of information currently receivable, or summary of contents of each of such pieces of information, transmits the selected information selected by the user to information attribute storage apparatus 122 and display information control apparatus 714, and transmits non-selected information not selected by the user to non-selected information attribute searching apparatus 740.

(2) Input apparatus 710 additionally has a function used for operating non-selected information attribute searching apparatus 740.

(3) Input signal processing apparatus 712 has a function of transmitting an instruction signal also to non-selected information attribute searching apparatus 740.

(4) Comparison control apparatus 734 compares with the user profile not only the information extracted by information attribute storage apparatus 122 but also the information attribute searched and extracted by non-selected information attribute searching apparatus, calculates degree of conformity between the user profile and the information that is currently receivable, regardless of whether it is displayed or not, and forms the conformity information.

(5) Display information control apparatus 714 additionally has a function of forming a marker for presenting the conformity information of the non-selected information.

In the following, a control structure of a program for implementing a desired function related to the system of information viewing apparatus 700 in accordance with the present embodiment will be described.

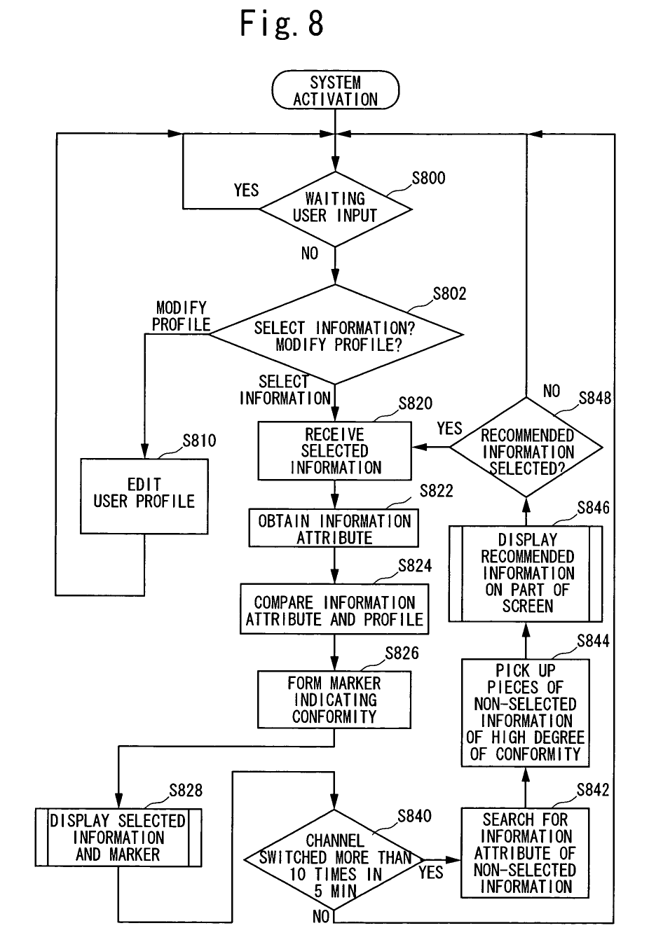

FIG. 8 is a flow chart of the information viewing program executed by information viewing apparatus 700. Of the steps shown in FIG. 8, the control structure from S800 through S802 to S810 and from S810 back to S800 is the same as the control structure shown in FIG. 2, from S200 through S202 to S210 and from S210 back to S200. Further, the control structure from S800 through S802 to S820, and then proceeding to S822, S824, S826 and S828 is the same as the control structure from S200 through S202 to S220, and then proceeding to S222, S224, S226 and S228. Therefore, detailed description thereof will not be repeated here.

In information viewing apparatus 100 in accordance with the first embodiment, in S228, information display apparatus 116 displays the information selected by the user together with the marker of the conformity information, and then, control returns to S200. In contrast, in information viewing apparatus 700 in accordance with the present embodiment, in S828, information display apparatus 116 outputs display information including the selected information and the marker of the conformity information, and then control proceeds to S840.

In S840, it is determined whether the information currently displayed is of interest to the user and hence the user is taking time to enjoy the displayed information, or the information is not interesting and the user is looking for some information to watch. As an exemplary method of determination, if the user selects and re-selects information to be viewed more than ten times in five minutes, it might be determined that the user is looking for some information he/she wants to see.

If it is determined that the currently displayed information is of interest to the user, control returns to S800. On the contrary, if it is determined that the user is looking for some information he/she wants to see, control proceeds to S842.

In S842, non-selected information attribute searching apparatus 740 receives from information receiving apparatus 708 pieces of information that can be received, other than the information currently viewed by the user, and extracts information attribute of each of the received pieces of non-selected information. Then, control proceeds to S844.

In S844, comparison control apparatus 734 refers to and compares the user profile and the information attribute of each piece of non-selected information extracted by non-selected information attribute searching apparatus 740 in S842, and calculates the degree of conformity. After the degree of conformity is calculated, one or more having high degree of conformity are picked up as recommended information. Comparison control apparatus 734 forms the conformity information for each of the picked-up information. Here, the recommended information refers to the piece of information of which calculated degree of conformity is high, that is, the information possibly of high interest to the user.

In S844, display information control apparatus 714 forms a marker supporting identification of the recommended information by the user, such as the title of the recommended information or of conformity information, a logo mark, summary of the recommended information, or a figure or sign indicating the contents. Then, control proceeds to S846.

In S846, the recommended information and the formed marker are transmitted to information display apparatus 116, and displayed as a part of the display on information display apparatus 116. Then, control proceeds to S848.

In S848, if the user selects a program to be viewed from the recommended information, control returns to S820. Otherwise, control returns to the standby state of 800, to wait for an input.

In S840, the condition for determining whether the control should proceed to S842 or return to S800 is not limited to the example described above, which depends on the number of selection and re-selection of information to be viewed in a prescribed time period. For example, the control may be set to always return to S800, and switched to proceed to S842 only at a time designated by the user. Alternatively, when the user instructs display of the recommended information using input apparatus 710, control may be switched to proceed to S842.

In S842, when non-selected information attribute searching apparatus 740 extracts the information attribute of non-selected information, the method to be used is not limited to the one in which the information attribute of every piece of receivable information is extracted. By way of example, a method may be used in which the information attribute is extracted only from the pieces of information that have some relevance to the currently viewed information, such as the pieces of information belonging to the same category as the currently viewed information. The object from which the information attribute is extracted may be narrowed down by some other method.

In S844, when the degree of conformity between the user profile and the information attribute of the non-selected information is calculated, the method to be used is not limited to the one in which the degree of conformity is calculated for every item registered in the user profile. By way of example, a method may be used in which the degree of conformity is calculated only for the category or keyword designated by the user. In S844, as the number of pieces of information to be picked-up, the total number or number per category may be determined in advance, or the user may be allowed to set an arbitrary number. Alternatively, the number of pieces of information to be picked-up may not be determined in advance but all the pieces that have the degree of conformity exceeding a certain threshold may be displayed.

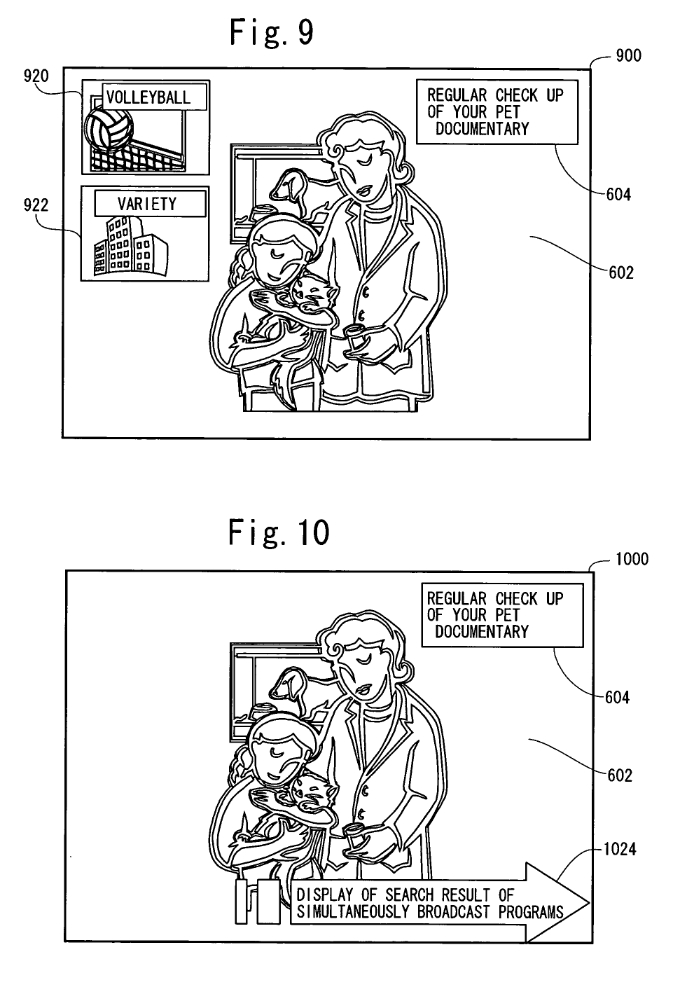

An exemplary operation of the information viewing system in accordance with the present embodiment will be described with reference to FIGS. 9 and 10, in accordance with the control structure of the program shown in FIG. 8.

The operation from the activation of information viewing apparatus 700 to the output of display information by information display apparatus 116, and the operation when the user edits the user profile are the same as those of information viewing apparatus 100 in accordance with the first embodiment. Therefore, detailed description thereof will not be repeated here.

The information shown in FIG. 6 above will be used as an example of the information selected by the user having low degree of conformity, or the information having high degree of conformity but not currently wanted by the user, in describing the operation after S840 of FIG. 8.

When the selected information selected by the user has low degree of conformity, or the information has high degree of conformity but not currently wanted by the user, the user repeatedly selects and re-selects information frequently, looking for a piece of information interesting enough to watch. When non-selected information attribute searching apparatus 740 detects that the user is repeating selection and re-selection, non-selected information attribute searching apparatus 740 receives from information receiving apparatus 708 non-selected information that has not yet viewed by the user, among the currently receivable information. When the information attribute of the received non-selected information is extracted by non-selected information attribute searching apparatus 740, comparison control apparatus 734 compares the attribute information of the non-selected information with the user profile, calculates each degree of conformity, picks up information having high degree of conformity and forms recommended information.

Referring to FIG. 9, display information 900 includes selected information 602, and a marker 604 indicating the title and category thereof. This is the same as the state of FIG. 6. When the recommended information is complete, markers 920 and 922 representing the recommended information are displayed on a part of display information 900. Referring to markers 920 and 922, the user can select information to be viewed, from the recommended information.

The method of display when there are pieces of recommended information is not limited to the one shown in FIG. 9. As shown in FIG. 10, that the search for recommended information has been finished and the display is available may be indicated by a marker 1024, urging the user to have a list of recommended information displayed. When the user has difficulty in determining information to be viewed, this operation supports searching of desired information by the user, as the piece of information to be viewed can be picked-up and presented among the recommended information having higher degree of conformity.

In the present embodiment, in response to the detection that the user repeats selection and re-selection of information, non-selected information attribute searching apparatus 740 receives the non-selected information from information receiving apparatus 708. The non-selected information attribute searching apparatus 740, however, may receive the non-selected information and may extract information attribute in advance, before detecting that the user repeats selection and re-selection of information.

### THIRD EMBODIMENT

In the first and second embodiments, edition of the user profile is executed in accordance with an operation by the user. The present invention, however, is not limited to such an embodiment.

The information viewing apparatus in accordance with the third embodiment has a function of managing information viewing history of the user and automatically modifying the user profile in accordance with the viewing history. By this function, the user profile comes to more closely reflect the change in taste of the user, and it becomes possible to support the user in more accurately finding the information to the user's taste. Further, as the viewing history of the user is managed, information viewed in the past can be viewed again easily.

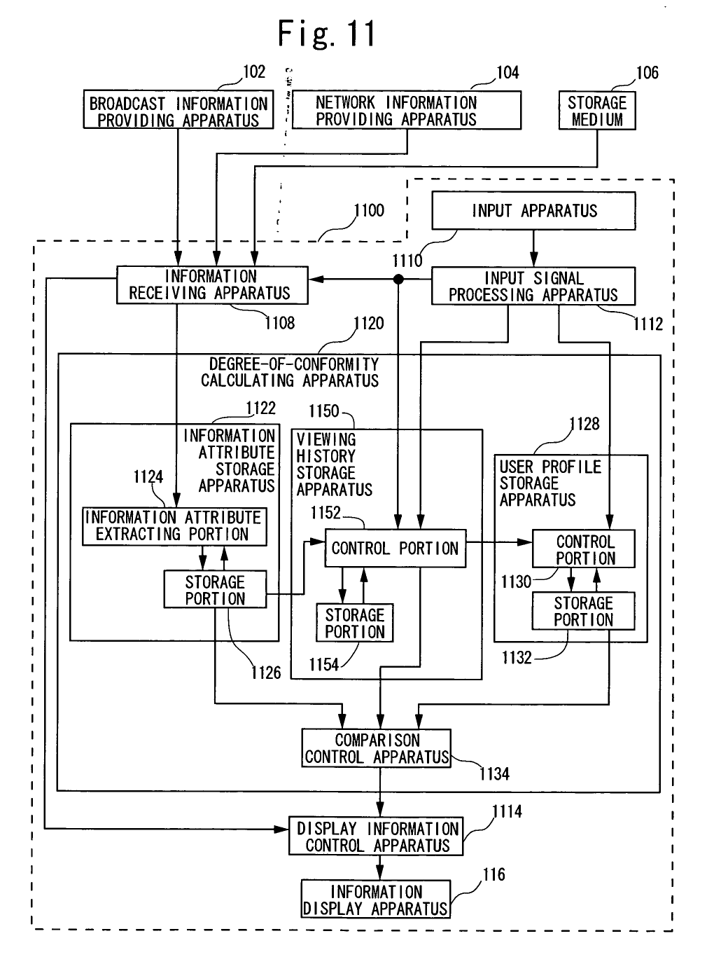

FIG. 11 is a block diagram representing a configuration of an information transmitting system including an information viewing apparatus 1100 in accordance with the present embodiment. Referring to FIG. 11, information viewing apparatus 1100 is connected to an information source such as broadcast information providing apparatus 102, network information providing apparatus 104 or recording medium 106.

Information viewing apparatus 1100 includes an input apparatus 1110, an input signal processing apparatus 1112, an information receiving apparatus 1108, a degree-of-conformity calculating apparatus 1120, a display information control apparatus 1114, and an information display apparatus 1116.

Degree-of-conformity calculating apparatus 1120 includes an information attribute storage apparatus 1122, a user profile storage apparatus 1128, a comparison control apparatus 1134, and a viewing history storage apparatus 1150. Information attribute storage apparatus 1122 includes an information attribute extracting portion 1124 and a storage portion 1126. User profile storage apparatus 1128 includes a control portion 1130 and a storage portion 1132. Viewing history storage apparatus 1150 includes a control portion 1152 and a storage portion 1154. Details of the apparatuses included in degree-of-conformity calculating apparatus 1120 will be described later.

Information viewing apparatus 1100 is different from information viewing apparatus 100 in accordance with the first embodiment in that it includes degree-of-conformity calculating apparatus 1120 in place of degree-of-conformity calculating apparatus 120. Degree-of-conformity calculating apparatus 1120 differs from degree-of-conformity calculating apparatus 120 in that degree-of-conformity calculating apparatus 1120 includes viewing history storage apparatus 1150.

Viewing history storage apparatus 1150 is connected to input signal processing apparatus 1112, storage portion 1126 of information attribute storage apparatus 1122, control portion 1130 of user profile storage apparatus 1128 and to comparison control apparatus 1134, and includes control portion 1152 and storage portion 1154 storing viewing history of the user and information attribute of information to be registered as viewing history, under the control of control portion 1152.

As degree-of-conformity calculating apparatus 1120 includes viewing history storage apparatus 1150, information viewing apparatus 1100 in accordance with the third embodiment is different from information viewing apparatus 100 in accordance with the first embodiment and from information viewing apparatus 700 in accordance with the second embodiment in the following points.

(1) Storage portion 1126 of information attribute storage apparatus 1122 is accessible not only from comparison control apparatus 1134 but also from control portion 1152 of viewing history storage apparatus 1150.

(2) Control portion 1130 of user profile storage apparatus 1128 not only edits the user profile based on an instruction signal from input signal processing apparatus 1112, but performs an object of interest extracting process of extracting information attribute stored in viewing history storage apparatus 1150 and an extracted information registering process of adding the same to the user profile stored in storage portion 1132, thereby modifying the user profile.

(3) Comparison control apparatus 1134 forms the conformity information from the user profile and the information attribute stored together with the history in viewing history storage apparatus 1150.

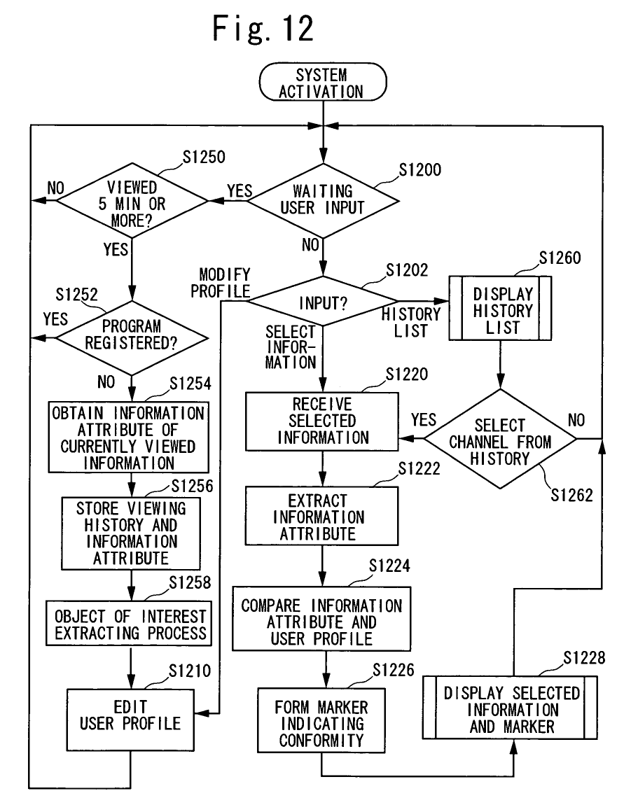

In the following, a control structure of a program for implementing a desired function related to the system of information viewing apparatus in accordance with the present embodiment will be described. FIG. 12 shows a flow chart of the information viewing program executed by information viewing apparatus 1110.

In S1200, the control is in a state of waiting for a user input, as in S200 of the first embodiment. In S200 of the first embodiment, when it is determined that there is no user input, S200 is simply repeated, waiting for an input. In contrast, in S1200, when it is determined that there is no user input, control proceeds to S1250. The control after S1250 will be described in detail later. When it is determined in S1200 that there is a user input, control proceeds to S1202.

In S1202, similar to S202 of the first embodiment, based on the input signal received by input signal processing apparatus 1112, the operation by the user is determined. In the present embodiment, however, the user operation includes an operation of selecting information he/she wants to see, an operation of editing the user profile and, in addition, an operation of requesting display of a list of viewing history. When the user operation is a request for displaying the list of viewing history, input signal processing apparatus 1112 converts the input signal to an instruction signal to viewing history storage apparatus 1150, and transmits the same. Then, control proceeds to S1260. Details of control flow after S1260 will be described later.

The control flow from step S1202 to S1210 and back to S1200 is the same as the control from S202 to S210 and back to S200 in the first embodiment.

Further, the control from step S1202 to S1220, S1222, S1224, S1226 and S1228 and back to S1200 is the same as the control from S202 to S220, S224, S226, and S228 and back to S200 of the first embodiment. Therefore detailed description thereof will not be repeated here.

As described above, if it is determined in S1200 that there is no input from the user, control proceeds to S1250.

In S1250, control portion 1152 of viewing history storage apparatus 1150 measures how long the information currently viewed by the user has been kept presented from the start. When a prescribed time period, for example, 5 minutes or longer has passed from the start of presenting the information, it is determined that the information currently presented by viewing apparatus 1110 is of high interest to the user. Therefore, control proceeds to S1252 for registering the information with the viewing history. If five minutes have not yet passed from the start of presentation, control returns to S1200, to wait for an input.

In S1252, whether the currently viewed information has been registered as viewing history in storage portion 1154 of viewing history storage apparatus 1150 or not is searched by control portion 1152 of viewing history storage apparatus 1150. If it has been registered, control returns to S1200. If not, control proceeds to S1254.

In S1254, control portion 1152 of viewing history storage apparatus 1150 obtains from storage portion 1126, the information attribute extracted from the currently viewed information by information attribute storage apparatus 1122 in S1222 while waiting for an input from the user. Then, control proceeds to S1256.

In S1256, the obtained information attribute and the viewing history are stored together in storage portion 1154. Control proceeds to S1258.

In S1258, control portion 1130 of user profile storage apparatus 1128 performs the object of interest extracting process for extracting information attribute stored in viewing history storage apparatus 1150. The extracted information attribute is the contents to be added by the modification of user profile. Then, control proceeds to S1210.

When control proceeds from S1258 to S1210, control portion 1130 modifies the user profile stored in storage portion 1132, based on the attribute information extracted in S1258. Here, in order to register the information attribute extracted in S1258 as information attribute of the information possibly of high interest to the user, the extracted information attribute is added to the user profile stored in storage portion 1132. Then, control returns to S1200.

As described above, if it is determined that the signal input by the user through input apparatus 1110 in S1202 requests display of a list of viewing history by input signal processing apparatus 1112, control proceeds to S1260.

In S1260, in accordance with the instruction signal transmitted by input signal processing apparatus 1112 in S1202, control portion 1152 of viewing history storage apparatus 1150 reads the viewing history and the information attribute stored in association with the viewing history from storage portion 1154, forms a list of viewing history (hereinafter referred to as “history list”), and transmits the history list to comparison control apparatus 1134.

Comparison control apparatus 1134 forms the conformity information using the information attribute in the transmitted history list, and transmits the history list with the conformity information attached, to display information control apparatus 1114. Based on the transmitted history list, display information control apparatus 1114 forms the display information. Information display apparatus 116 displays the display information. Then, control returns to 1200.

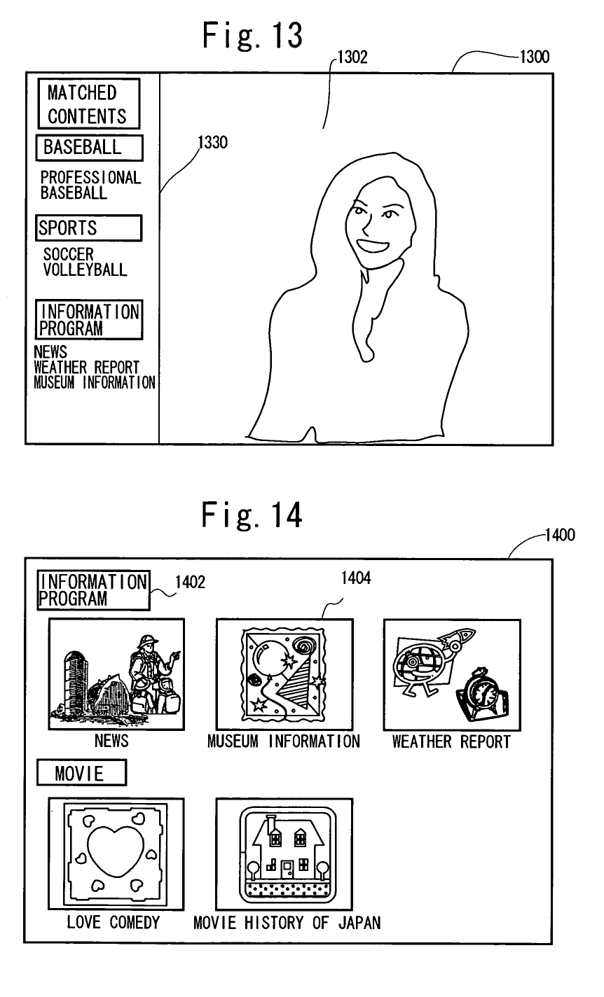

An exemplary operation of the system of information viewing apparatus 1100 in accordance with the present embodiment will be described with reference to FIGS. 13 and 14, in accordance with the control structure of the program shown in FIG. 12.

Of the series of operations executed by information viewing apparatus 1100, the operation from the activation of the system to the output of display information by information display apparatus 116, and the operation when the user edits the user profile are the same as those of information viewing apparatus 100 in accordance with the first embodiment. Therefore, detailed description thereof will not be repeated here.

It is noted, however, that information viewing apparatus 1100 continuously performs an operation of updating the viewing history, while it presents information to the user through the same operation as that of information viewing apparatus 100 in accordance with the first embodiment. If the user continuously views the currently presented information for more than five minutes, the viewing history is registered through the series of control from S1250 to S1258 and S1210, so that the user profile is updated.

When the user makes an operation of requesting display of the history list, the history list is displayed under the control of S1260. As to the manner of displaying the history list, titles 1330 of pieces of information may be displayed classified in accordance with keywords or categories, on a part of the screen 1330, while the currently viewed information 1302 is kept presented, as shown in FIG. 13. Here, other information attributes of the information, such as the producer, performer, sponsor of the information, or information attributes in association to any person related to the information may additionally be displayed.

Further, as shown in FIG. 14, images 1404 representing parts of the information or for supporting identification of information may be classified in accordance with keywords or categories and displayed item by item 1402 of classification, and information titles may be displayed below the images 1404 for supporting identification of information, on the entire screen 1400, like a general thumb-nail display. Alternatively, video images introducing information may be successively given in thumb-nail display.

The order of displaying the items in the history list may be in accordance with categories, keywords, or in accordance with the degree of conformity, from the higher one, or any other order. All the pieces of information stored in the viewing history does not have to be displayed. A certain threshold value may be set and only the pieces of information having the degree of conformity higher than the threshold may be displayed in the history list, or history of only those that match a user selected condition may be displayed. Further, the manner of display may be changed by an operation of the input apparatus or the like.

After the history list is displayed, when the user selects information listed in the history list, the selected information is displayed.

Through the above-described operation, the user profile comes to be the one that reflects the change in taste of the user, and thus, it becomes possible to help the user to more accurately find the information suited to the taste of the user.

As described above, by the embodiment of the present invention, the user can freely select information, and information indicating how much the selected information is to the taste of the user is displayed together. It is possible for the user to freely select among a huge amount of information and to easily know information possibly of high interest to him/her.

Further, the user himself/herself is allowed to edit the user profile, and further, information can be added to or removed from the user profile based on the viewing history by the user, so that the user profile can be modified. When the user turns his/her interest from one object to another, such a change in user's taste can flexibly be addressed.

When needed, selectable pieces of information in a limited range may be displayed, allowing the user to select a desired piece of information therefrom. This can reduce search time.

In the third embodiment described above, the information related to the viewing history, or the contents of user profile modified based on the viewing history, may be organized in accordance with the period of time from storage or modification, so as to reflect the current taste of the user.

By way of example, control portion 1152 of viewing history storage apparatus 1150 may organize the viewing history of the user and the information attribute of pieces of information to be registered as viewing history stored in storage portion 1154, considering the period of time since these are stored. Specifically, information that has been stored for more than a prescribed time period may be removed. Alternatively, information held for a long period of time may be removed upon satisfaction of a condition that the total amount of information stored in storage portion 1154 reached a prescribed amount. Further, of the pieces of information that have kept for a prescribe time period or longer, those the user has viewed for only a short time may be removed.

Further, the contents of user profile modified based on the viewing history may be removed or priority thereof may be changed, based on the period of time since they are modified.

In the third embodiment described above, an example has been described in which information viewing apparatus 1100 registers viewing history of information determined to be of possibly high interest to the user and changes the user profile. As an opposite approach, information viewing apparatus 1100 may additionally change the user profile regarding information considered to be of no interest to the user.

For instance, among the pieces of information presented to the user as recommended information, history of those not selected by the user may be separately registered. Such a piece of information that was presented as recommended information but not selected may be information that had been of interest to the user in the past but not of interest at present, or information the user got tired of Information attribute of such information may be removed from the user profile, or priority thereof in the user profile may be lowered.

In the third embodiment, as an example of the method of determining whether the user is interested in the displayed information or not, a method has been described in which duration of viewing of the information is measured. The method of determining whether the user is interested in the displayed information or not is not limited to such a method. By way of example, how much the user is interested in the information that is being displayed may be evaluated by the user and the result of evaluation may be input, and the user profile may be modified based on the input result of evaluation.

As another example, the number of times the user viewed pieces of information in which a certain performer appears may be counted, and when the number of viewing exceeds a prescribed value, a keyword or category related to the performer may be added. Alternatively, the number of times the user viewed pieces of information associated with a keyword or category already stored in the user profile may be counted, and the priority of the keyword or category may be modified based on the number of viewing.

In the first, second and third embodiments described above, the information attribute extracting portion extracts the information attribute from the selected information. The method of obtaining the information attribute, however, is not limited thereto. For example, the information providing apparatus may prepare the information attribute of the information to be provided separate from the information to be provided, and the information attribute may be provided as such. In that case, the information attribute extracting portion may obtain the information attribute prepared by the information providing apparatus through the information receiving apparatus, rather than extracting the information attribute from the selected information.

As an example of the information viewing apparatus in accordance with the first, second and third embodiments above, an arrangement in which the apparatuses and portions forming the information viewing apparatus are provided integrally has been described. The present invention, however, is not limited to such an embodiment. The apparatuses and portions forming the information viewing apparatus may be divided into two or more components. For example, information attribute storage apparatus 122, user profile storage apparatus 128 and comparison control apparatus forming the degree-of-conformity calculating apparatus may exist in components separate from each other, and necessary information may be transmitted/received through communication. Further, information related to the information attribute, user profile and to the viewing history stored in respective storage portions of the information attribute storage apparatus, user profile storage apparatus and viewing history storage apparatus may be stored in detachable recording media such as a card-type storage, and comparison control apparatus 1134 may read information appropriately from such media. When the apparatuses and portions forming the information viewing apparatus are divided into two or more components, it is necessary that these can communicate with each other.

The information viewing apparatus described as an example in the first, second and third embodiments may be implemented with hardware and may also be implemented with a computer and software running on the computer.

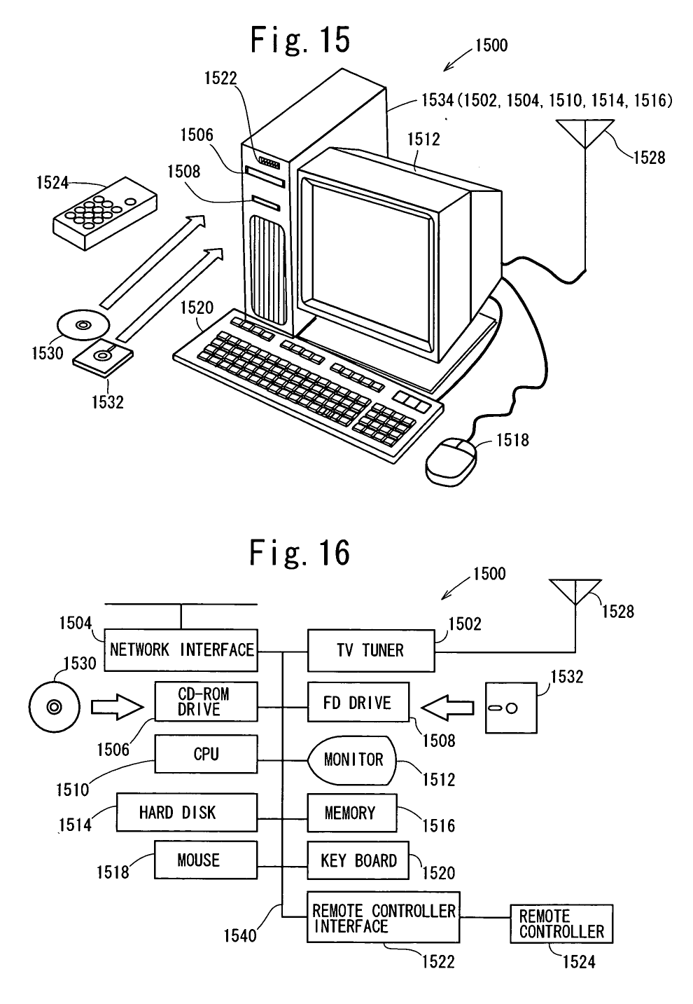

FIG. 15 shows an appearance of a computer system 1500 implementing the present embodiment, and FIG. 16 is a block diagram showing the configuration of computer system 1500. Here, computer system 1500 is only an example, and various other configurations may be possible.

Referring to FIG. 15, computer system 1500 includes a computer 1534, and a TV (Television) antenna 1528, a monitor 1512, a mouse 1518, a keyboard 1520 and a remote controller 1524, which are all connected to computer 1534. Computer 1500 further includes a CD-ROM drive 1506 and an FD (Flexible Disk) drive 1508.

Referring to FIG. 16, computer system 1500 further includes, in computer 1534, a bus 1540 connected to CD-ROM drive 1506 and FD drive 1508, a central processing unit (CPU) 1510, a memory 1516 including an ROM (Read-Only Memory) storing a boot up program of computer 1534 and an RAM (Random Access Memory) providing a work area used by the CPU and a storage area for a program executed by CPU 1510, a hard disk 1514, a TV tuner 1502, a network interface 1504, and a remote controller interface 1522, all connected to the bus 1540.

The control portion of information attribute control apparatus, the control portion of user profile storage apparatus, the comparison control apparatus, the display information control apparatus, and the input signal processing apparatus of the first, second and third embodiments, the non-selected information attribute searching apparatus of the second embodiment, and the control portion of viewing history storage apparatus of the third embodiment perform various controls in accordance with the control structures shown above. Various controls performed by these apparatuses and various other controls related to the system may be executed collectively by CPU 1510.

The storage portion of information attribute storage apparatus and the storage portion of user profile storage apparatus of the first, second and third embodiments, the non-selected information attribute searching apparatus of the second embodiment, and the storage portion of viewing history storage apparatus of the third embodiment store various information such as information attributes, user profile, and viewing history. Such information to be stored and other information to be stored in relation to the operation of the system may be stored in hard disk 1514, FD 1532 or memory 1516.

The software implementing the system of the above-described embodiments is distributed recorded on a recording medium such as CD-ROM 1530, read to computer 1534 through a reading apparatus such as CD-ROM drive 1506, and stored in hard disk 1514. When the CPU executes this program, the program is read from hard disk 1514 and stored in memory 1516, an instruction is read from an address designated by a program counter, not shown, and executed. CPU 1510 reads data to be processed from hard disk 1514, and stores the result of processing again in hard disk 1514.

The operation of computer system 1400 itself is well-known, and therefore, details thereof will not be described here.

The manner of distribution of the software is not limited to the fixed form recorded on a storage medium as described above. By way of example, it may be distributed such that the data is received from another computer connected through a network. A manner of distribution is also possible in which part of the software is stored in hard disk 1514, and the remaining part is read to the hard disk through the network, to be integrated at the time of execution.

Generally, a program of late utilizes general functions provided by an operating system (OS) of the computer or by a so-called third party, and execute these in an organized manner in accordance with a desired objective, to attain the above-described desired objective. Therefore, even a program or programs not including the general functions provided by the OS or third party among various functions of the above-described embodiments but simply designating a combination of execution order of such general functions are clearly encompassed in the technical scope of the present invention, as long as the program or programs as a whole have the control structure that attains the desired objective using these functions.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

As described above, the present invention can be utilized in a broadcasting system, an information network and a system for outputting information transmitted through an information medium including a storage medium, and particularly to a system that allows efficient selection and output of various and many pieces of information while maintaining versatility of the information to be output.

1-26. (canceled)

27. An information viewing apparatus, comprising:
information selecting means for selecting, from pieces of information provided from a prescribed information source, a piece of information as an object to be presented to the user, based on a user input;
user profile storing means for storing user profile information representing one or both of user's interest and preference;
first means for calculating degree of conformity between the piece of information selected by said information selecting means and said user profile information stored by said user profile storing means;
means for forming a piece of conformity information representing conformity between said selected piece of information and said user profile information, based on said degree of conformity; and
first means for presenting said piece of conformity information and said selected piece of information together, when a value of said degree of conformity satisfying a prescribed condition is calculated by said first means for calculating degree of conformity.

28. The information viewing apparatus according to claim 27, further comprising:
pick-up means for picking-up a piece of information among pieces of information not selected by said information selecting means, in accordance with a prescribed pick-up method; and
second means for presenting a prescribed presentation related to the piece of information picked-up by said pick-up means.

29. The information viewing apparatus according to claim 28, wherein
said pick-up means includes means for picking-up a piece of information among the pieces of information not selected by said information selecting means in accordance with said prescribed pick-up method, when said user input to said information selecting means is made by a frequency higher than a prescribed reference.

30. The information viewing apparatus according to claim 28, wherein
said first means for presenting information includes first display means for displaying, on a screen of a prescribed display apparatus, said conformity information and the piece of information selected by said information selecting means together, when a value of said degree of conformity satisfying said prescribed condition is calculated by said first means for calculating degree of conformity; and
said second means for presenting information includes second display means for displaying, on a prescribed area on said screen, visual presentation of the piece of information picked-up by said information pick-up means.

31. The information viewing apparatus according to claim 30, wherein
said second display means includes means for generating a prescribed marker corresponding to the piece of information picked-up by said pick-up means and suggesting contents of the picked-up piece of information, based on the picked-up piece of information, and displaying the marker on said prescribed area; and
said information selecting mean includes means for selecting a piece of information corresponding to the marker, as the piece of information to be presented to the user, based on selection of said marker by said user.

32. The information viewing apparatus according to claim 30, wherein
said second display means includes means for generating and displaying on said prescribed area a marker representing that a piece of information has been picked-up by said pick-up means;
said information viewing apparatus further comprising
means for displaying a list of information picked-up by said pick-up means, upon receiving a prescribed input from the user, in response to display of said marker.

33. The information viewing apparatus according to claim 28, wherein
said pick-up means includes
second means for calculating degree of conformity for comparing said non-selected piece of information with said user profile information, and calculating degree of conformity between said non-selected piece of information and said user profile; and
means for picking-up a piece of information, of which value of degree of conformity calculated by said second means for calculating degree of conformity satisfies a prescribed condition, from said non-selected pieces of information.

34. The information viewing apparatus according to claim 33, wherein
said second means for calculating degree of conformity includes
narrowing means for narrowing down said non-selected pieces of information in accordance with a prescribed reference of narrowing down, as the object of comparison with said user profile information; and
means for calculating degree of conformity between the piece of information narrowed down by said narrowing means and said user profile information.

35. The information viewing apparatus according to claim 34, wherein
the pieces of information provided by said prescribed information source are classified into prescribed categories; and
said narrowing means includes means for narrowing down said non-selected pieces of information as the object of comparison with said user profile information to be in the same category as the piece of information selected by said information selecting means.

36. The information viewing apparatus according to claim 33, wherein
said second means for calculating degree of conformity includes means for calculating degree of conformity between said non-selected piece of information and a user-designated piece of said user profile information.

37. The information viewing apparatus according to claim 33, wherein
the pieces of information provided by said prescribed information source includes pieces of information that are being provided by said information source and pieces of information expected to be provided from said information source;
said information selecting means includes means for selecting a piece of information as the object to be presented to the user, from said pieces of information that are being provided, based on a user input; and
said second means for calculating degree of conformity includes
means for obtaining information attribute of said non-selected piece of information from said prescribed information source, and
means for comparing the information attribute of said non-selected piece of information with said user profile information stored by said user profile storing means and calculating degree of conformity between said non-selected piece of information and said user profile information.

38. The information viewing apparatus according to claim 27, further comprising:
second means for calculating degree of conformity for comparing said non-selected piece of information not selected by said information selecting means with said user profile information, and calculating a degree of conformity between said non-selected piece of information and said user profile; and
means for making a prescribed presentation when a value of said degree of conformity satisfying a prescribed condition is calculated by said second means for calculating degree of conformity.

39. The information viewing apparatus according to claim 27, further comprising
means for editing said user profile information stored in said user profile storing means, based on a user input.

40. The information viewing apparatus according to claim 27, further comprising
means for stopping presentation of said conformity information by said first means for presenting information after a prescribed time period from the start of presentation of the information by said first means for presenting information.

41. The information viewing apparatus according to claim 27, further comprising
history storing means for storing a history of information selection by said information selecting means.

42. The information viewing apparatus according to claim 41, wherein
said history storing means includes means for storing, when the degree of conformity calculated by said first means for calculating degree of conformity of the piece of information selected by said information selecting means satisfies a prescribed condition, history of selection of said piece of information.

43. The information viewing apparatus according to claim 27, further comprising:
means for storing history of selection by said information selecting means and the information selected by said information selecting means together.

44. The information viewing apparatus according to claim 43, further comprising
determining means for determining, based on a user input, whether the piece of information presented by said first means for presenting information is of interest to the user or not; wherein
said means for storing together stores both the history of selection of the piece of information determined by said determining means to be of interest and the piece of information;
said information viewing apparatus further comprising:
extracting means for extracting a piece of information representing an object of interest to the user, based on the information stored by said means for storing together; and
means for having the piece of information extracted by said extracting means stored in said user profile information storing means.

45. The information viewing apparatus according to claim 43, further comprising
determining means for determining, based on a user input, whether the piece of information provided by the information source is of interest to the user or not; and
means for extracting, from the piece of information determined to be of no interest to the user by said determining means, a piece of information related to an item represented by the information, and for editing said user profile information based on the extracted information related to the item.

46. The information viewing apparatus according to claim 43, further comprising:
list display means for forming and displaying a list of pieces of information stored by said means for storing together, in response to a prescribed input by the user.

47. The information viewing apparatus according to claim 46, further comprising:
means for having said information selecting means, when the user selects a piece of information by using items of said list displayed by said list displaying means, select the piece of information selected by the user.

48. The information viewing apparatus according to claim 27, wherein
said first means for presenting information includes
means for obtaining, when a piece of information is selected by said information selecting means and a value of said degree of conformity satisfying a prescribed condition is calculated by said first means for calculating degree of conformity, said selected piece of information; and
means for presenting the piece of information obtained by said obtaining means and said conformity information together.

49. A computer readable recording medium recording a program that can be executed by a computer, controlling the computer such that the computer operates as the information viewing apparatus according to claim 27.

50. An information viewing method supporting selection by a user of a piece of information to be viewed, comprising:
the step of selecting, from pieces of information provided from a prescribed information source, a piece of information as an object to be presented to the user, based on a user input;
the step of storing user profile information representing one of or both of user's interest and preference;
the step of calculating degree of conformity between the piece of information selected in said selecting step and said user profile information stored in said storing step;
the step of forming, based on said degree of conformity, a piece of conformity information representing conformity between said selected piece of information and said user profile information; and
the step of presenting said piece of conformity information and said selected piece of information together, when a value of said degree of conformity satisfying a prescribed condition is calculated in said step of calculation.

51. The information viewing method according to claim 50, further comprising:
the step of picking-up, in accordance with a prescribed pick-up method, a piece of information from pieces of information not selected in said step of selecting; and
the step of making a prescribed presentation related to the piece of information picked-up in said pick-up step.

52. The information viewing method according to claim 51, wherein
said step of picking-up includes the step of picking-up, when user input in said selecting step is made by a frequency higher than a prescribed reference, a piece of information from pieces of information not selected in said step of selecting, in accordance with said prescribed pick-up method.

53. The information viewing method according to claim 50, wherein
said step of presenting includes the step of displaying, on a screen of a prescribed display apparatus, said conformity information and said piece of information selected in said selecting step, when a value of said degree of conformity satisfying a prescribed condition is calculated in said calculating step; and
said step of making a presentation includes the step of displaying, on a prescribed area of said screen, an image related to presentation of the piece of information picked-up in said step of picking-up.
